(19) United States
(12) Patent Application Publication
(10) Pub. No.: US 2008/0189731 A1
(43) Pub. Date: Aug. 7, 2008

(54) Disk Drive Unit Having A Clamper System With Variable Clamping Force

(75) Inventor: Kum Chung Loh, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,095

(22) PCT Filed: Jan. 18, 2006
(86) PCT No.: PCT/IB06/50182

§ 371 Date: Jul. 17, 2007

(30) Foreign Application Priority Data
Jan. 20, 2005 (EP) 05100345.7

(51) Int. Cl. G11B 23/00

(52) U.S. Cl. 720/710

(57) ABSTRACT

The invention relates to a disk drive unit for a disk (D) to be used in a device for reading and/or writing the disk at high rotational speeds of the disk. It comprises a turntable (5) and a clamping mechanism (7, 11) to hold the disk firmly on the turntable. A clamper (7) thereof is adapted to be provided on a side of the disk (D) facing away from the turntable (4) and includes at least one magnetizable portion. A magnet (11) is provided in the turntable and is movable in a direction to and away from the magnetizable portion of the clamper A centrifugal operating mechanism (16-21) is adapted to cause the magnet to move towards and away from the magnetizable portion of the clamper in dependence of the rotational speed of the turntable.

### FIELD OF THE INVENTION

The invention relates to a disk drive unit for a disk. Such a drive unit is particularly meant for use in a device for reading and/or writing data from or on the disk at high rotational speeds of the disk.

### BACKGROUND OF THE INVENTION

In disk drive units, especially in optical disk drive units, there is an ever increasing demand for high data transfer rates. This leads to increased turntable speeds, even up to 10,000 rpm. At these higher speeds higher clamping forces are required to prevent a disk clamped on the turntable from flying off. This is especially critical during operational shocks and when the turntable is in a vertical position.

To increase the clamping force of the clamper, the air gap present between the magnet in the turntable and the clamper can be reduced. Also a higher magnet grade could be used. However, a high clamping force causes some problems in the loader design. Disadvantages of a high clamping force are a.o. a high motor and driver IC dissipation, a poor motor lifetime, mechanical noise, stress in the loading system, a need for higher voltage supply and higher cost for the magnet.

The state of the art, these problems have been tackled by a clamping device with variable clamping force. Such device is disclosed in US 2002/0191531 A1. In this known device the clamper is provided with an annular magnet which can exert an attraction force on the turntable, and a linking member which can change the height of the annular magnet relative to the turntable according to the centrifugal force induced by variation of the rotational speed of the optical disk drive.

It is an object of the present invention to further improve the prior art disk drive units.

### SUMMARY OF THE INVENTION

For this purpose, the invention provides a disk drive unit according to claim 1.

The disk drive unit according to the invention has several advantages. First of all, now that the movable magnet is provided in the turntable and not in the clamper, the clamper assembly can be made lighter which minimizes the risk of a “flying disk”, especially during operational shocks. Also the centering of the clamper will be less critical as the clamper mass can be lowered. Furthermore, as the magnet and the speed dependent operating mechanism are built in the turntable, there is no risk that clamper slippage could affect the speed dependent operating mechanism which would be the case if the magnet and speed dependent operating mechanism are built in the clamper. The clamper would then be heavier and during high acceleration speeds the clamper could slip and the attraction force would not be increased properly then which would lead again to the risk of a “flying disk”.

Preferably the speed dependent operating mechanism is adapted as defined in a claim 2. In this embodiment, the attraction force causes the movements of the magnet and the speed dependent operating mechanism is just for controlling the distance between the magnet and the magnetizable portion of the clamper. This is a reliable and efficient way of controlling the magnet movement and the resulting attraction force.

One way of the carrying out this embodiment is defined in claim 3. Of course, the holding portion of the holder could co-operate with the magnet directly or with a yoke attached to the magnet, such as a yoke projecting radially outwardly beyond the magnet.

If the holding portion is wedge-shaped as defined in claim 4, the position of the magnet can be varied in a continuous manner. Preferably the holding portion is attached to a mass portion as defined in claim 5. A centrifugal operating mechanism uses a direct and reliable manner of transmitting a rotational speed into an operational movement. Furthermore in this embodiment, there is a direct transfer of forces from the mass portion(s) through the holding portion to the magnet. Preferably, the mass portions are positioned as close as possible to the motor as this will minimize inertia load on the motor.

Preferably, the holder comprises a plurality of mass portions as is defined in claim 7. In this manner it is possible to create a well-balanced design and, especially if the feature of claim 8 is used, it is possible to create a compact centrifugal operating mechanism, as the mass is spread out in circumferential direction.

The invention also provides a device for reading and/or writing data from or on a disk comprising the disk drive unit as described above.

These and other aspects of the invention will be apparent from and elucidated with reference to the embodiment described hereinafter and shown in the drawings.

### BRIEF DESCRIPTION OF THE DRAWINGS

FIG. 1 is a very schematic cross-section of a device for reading and/or writing an optical disk including the disk drive unit according to the invention.

FIGS. 2 and 3 are enlarged cross-sectional views of the turntable and disk clamped thereon at stationary or low speed (FIG. 2) and at high speed (FIG. 3).

FIG. 4 is a partial exploded view of the cross-section of FIGS. 2 and 3 showing parts separately.

FIG. 5 is a schematic plan view of the centrifugal operating mechanism from the turntable as shown in FIGS. 2 and 3.

### DETAILED DESCRIPTION OF A PREFERRED EMBODIMENT

The drawings show an embodiment of the disk drive unit. This disk drive unit may be used in a device for reading and/or writing data from or on a disk, such as an optical disk or the like. The device in which this disk drive unit is used may be a portable or a stationary device, such as an audio or video player and/or recorder or a data disk reader and/or writer. The optical disk in this embodiment may be a high speed CD/DVD/Blue Ray disk or the like.

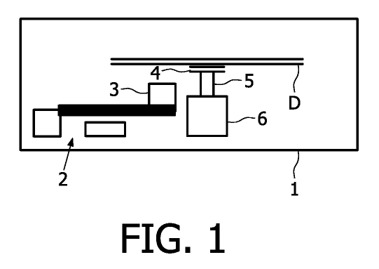

As shown in FIG. 1, the disk drive unit includes a housing 1 accommodating the disk drive unit. The disk drive unit comprises an optical system 2 including an optical pickup unit 3 and a turntable 4 for supporting a disk D. The turntable 4 is rotatably supported by a rotary spindle 5 which is rotatably mounted in a bearing column. The turntable 4 is preferably made of plastic and is attached to the free end of the rotary spindle 5. Attached to the lower side of the turntable 4 is a rotor which forms part of an electric motor 6.

The turntable 4 cooperates with a magnetizable metal (steel) clamper 7 positioned on a disk D (when it is positioned on the turntable 4) in order to firmly clamp this disk D down on the turntable to stabilise this disk D during rotation of the turntable 4, especially during high rotational speed. The clamper has an outer annular ridge 8 with which the clamper 7 can engage the disk D and has an inner annular projection 9 which engages, in operation, through an open end in a hub 10 on the turntable 4. This annular projection 9 of the clamper 7 is designed to cooperate with a magnet 11 which is provided in the turntable 4, in this case within the projecting hub 10 on the turntable 4. The projection 9 may engage into the hub 10 through the open top thereof to approach the magnet 11 leaving a small gap G in between. This hub 10 projects through a centre hole C in the disk D in order to centre the disk D on the turn table 2. A friction ring 12 may be provided on the turntable 4 to ensure that a disk D follows the rotation of the turntable 4, especially during accelerations and high speeds.

The magnet 11 has an annular shape and is provided around the spindle 3 and within an inner circumferential wall 13 in the hollow hub 10 of the turntable 4. Attached to the lower side (as seen in the drawings) of the magnet 11 is an annular yoke 14 which extends radially outwardly beyond the circumference of the magnet 11 and is thereby able to limit the upward movement of the magnet 11 due to its engagement with an annular shoulder 15 in the hub 10. The magnet 11 and the yoke 14 are able to slide in vertical direction along the spindle 3 to a limited extent. In its upper position, the magnet 11 is positioned such that there is still a minor air gap G between the upper surface of the magnet 11 and the lower surface of the projection 9 in the clamper 7.

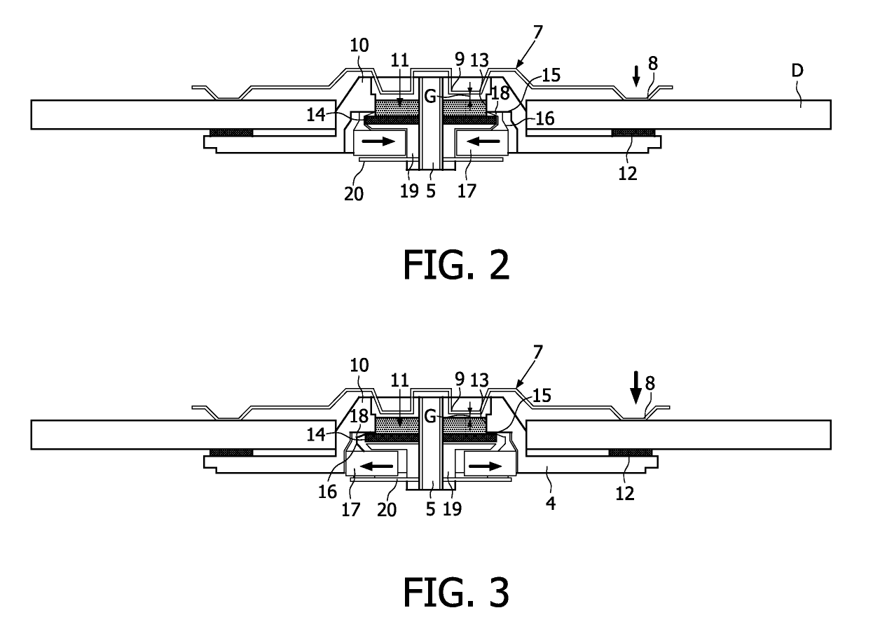

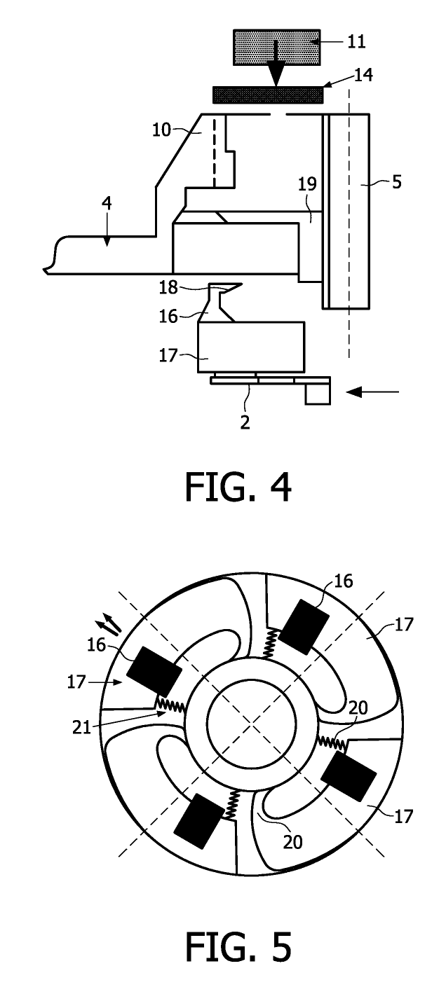

FIGS. 2-5 show in more detail a centrifugal operating mechanism in order to adjust the position of the magnet 11 in dependence of the rotational speed of the turntable 4. By adjusting the vertical position of the magnet 11, the air gap to the clamper 7 and therefore the attraction force on the clamper and consequently the clamping force of the clamper 7 on a disk D is adjusted.

The centrifugal operating mechanism includes four circumferentially spaced holders 16 adapted to lock the magnet 11 at standstill or low speeds and to release it at high speeds. Each holder 16 is attached to a corresponding mass 17 which is movable in radial direction or at least in a direction with a substantial radial component. The holder 16 is provided with a wedge-shaped holding portion 18 which is pointed radially inwardly and is able to engage around the yoke 14 such that in the locked position of the magnet 11 the holding portion 18 is positioned maximally between the yoke 14 and an annular shoulder 15. It thus prevents the yoke 14 and the magnet 11 to move towards the clamper 7. In this position of the holder 16, the yoke 14 is locked between the holding portions 18 and an underlying support 19 which is attached to the spindle 3.

Each mass 17 is positioned as close as possible to the motor 6 and each extends through an arc which in this case is slightly less than 90°. Thus there can be a relatively high weight in a small area. This may lead to a compact design, as is shown in FIG. 5, each mass 17 is provided on an spring support 20 which is attached on one circumferential end of the mass 17 to the support 19. On the other circumferential end of each mass 17 there is provided a radial spring 21 which is provided between the free end of the mass 17 and the support 19 in order to bias the mass 17 in radially inward direction together with the spring support 20. The spring support 20 allows a pivoting movement of the mass 17 around one of its ends which thereby causes a substantially radial movement of the holder 16 which is attached to the respective mass 17.

The operation of the centrifugal operating mechanism is as follows:

When the turntable is at standstill or at low speed (FIG. 2), the radial inward force exerted by the radial spring 21 and the spring support 20 on each mass 17 is such that the masses 17 are kept in the position according to FIG. 2. In this position, the holders 16 are in their radially inward position in which the yoke 14 of the magnet 11 is locked between the holding portions 18 of the holders 16 and the support 19. The gap G between the magnet 11 and the metal clamper 7 is such that the clamper 7 is attracted by the magnet 11 with a small attraction force leading to a small clamping force of the clamper 7 on the disk D. In this position it is easy to take off the clamper from the disk D without a substantial force.

If the turntable 4 is accelerated to higher speeds (FIG. 3) the centrifugal force on the masses 17 increases and at a certain speed, the centrifugal force will exceed the radially inward spring force so that the masses 17 will start moving radially outwardly. As a result, also the holder 16 and consequently the holding portion 18 will start moving radialy outwardly. When the holding portion 18 moves radially outwardly, the wedge shape thereof will become effective and the magnet 11 is then allowed to move increasingly towards the clamper 7. This movement of the magnet 11 is caused by the attraction force between the magnet 11 and the steel clamper 7 so that there is always and upward force on the magnet 11. Due to the upward movement of the magnet 11 the magnet 11 comes closer to the clamper 7 and the attraction force increases accordingly. Thus, the higher the rotational speed of the turntable 4, the more the clamping force of the clamper 7 on the disk D increases. This is very favourable as during high speed movement of the turntable 4, the forces on the disk D increase and thus more clamping force is needed to hold the disk D on the turntable 4, also in critical situations as during a shock.

When the rotational speed of the turntable 4 is decreased again, the radial forces by the spring 21 and the spring support 20 on the masses 17 exceed again the centrifugal forces on the masses 17 and therefore the masses 17 and the holders 16 are pulled radially inwardly. The wedge-shaped holding portions 18 are then wedged between the yoke 14 and the annular shoulder 15 and consequently the yoke 14 and the magnet 11 are urged downwardly, eventually to the locked position as shown in FIG. 2.

From the foregoing it will be clear that the invention provides a clamper system with variable clamper force which operates in a reliable and effective manner.

In the presently preferred embodiments, the disk D is an optical data disk. However, it should be understood that the invention can also be used for all kinds of disks, e.g. ferro-electric, magnetic, magneto-optic, optical, near-field, active charge storage disks or other disks using combinations of these techniques or other reading and/or writing techniques.

It is noted that in specification and claims, the use of the expressions “a” or “an” does not exclude a plurality thereof, whereas the expression “comprising” does no exclude additional elements or steps. The term substantially radial direction means that the direction should have a (significant) radial component but does not exclude directional components in axial or tangential directions. Any reference signs in the claims shall not be construed as limiting the scope thereof.

The invention is not restricted to the above-described embodiment as shown in the drawing, which can be varied in several ways without departing from the scope of the appended claims. For example, the position and shape of the magnet may be varied. The clamper (or a part co-operating with it) may be made partly of a magnetizable material. Other speed dependent operating mechanisms may be used.

1. A disk drive unit for a disk (D), particularly to be used in a device for reading and/or writing a disk at high rotational speeds of the disk, comprising:
a turntable (5) adapted to support the disk (D) thereon and being rotatably drivable by a motor (6);
a clamping mechanism to hold the disk firmly on the turntable, comprising a clamper (7) adapted to be provided on a side of the disk facing away from the turntable (4) and including at least one magnetizable portion, and comprising at least one magnet (11) provided in the turntable, the magnet being movable in a direction to and away from the magnetizable portion of the clamper, and a speed dependent operating mechanism (16-21) adapted to cause the magnet to move towards and away from the magnetizable portion of the clamper in dependence of the rotational speed of the turntable.

2. The disk drive unit of claim 1, wherein the speed dependent operating mechanism (16-21) is adapted to hold the magnet (11) away from the clamper (7) at low rotational speeds of the turntable (4), and to release the magnet when the turntable rotates at high rotational speeds.

3. The disk drive unit of claim 2, wherein the speed dependent operating mechanism (16-21) includes a substantially radially movable holder (16) and a spring member (20, 21) acting on the holder in radially inward direction, the holder comprising a holding portion (18) which is positioned between the magnet (11) and the magnetizable portion of the clamper at low speeds of the turntable (4) and is moved radially outwardly away from this position at high rotational speeds.

4. The disk drive unit of claim 3, wherein said holding portion (18) is wedge shaped.

5. The disk drive unit of claim 3, wherein the speed dependent operating mechanism (16-21) is a centrifugal operating mechanism, and wherein the holding portion (18) of the holder (16) is attached to a movable mass portion (17) of the centrifugal operating mechanism.

6. The disk drive unit of claim 3, wherein the holder (16) is provided with a radial spring (21).

7. The disk drive unit of claim 5, wherein the holder (16) comprises a plurality of mass portions (17) and attached holding portions (18) which are equally distributed around the axis of rotation of the turntable (4).

8. The disk drive unit of claim 7, wherein each mass portion (17) extends along an arc portion and is attached to the spindle on one circumferential end through an elastically bendable portion which allows the mass portion (17) to move in a controlled manner.

9. The disk drive unit of claim 3, wherein the magnet (11) is provided with a yoke (14) projecting radially outwardly beyond the magnet in order to co-operate with the holding portion (18) of the holder (16).

10. The disk drive unit of claim 1, wherein the turntable (4) is provided with a hub (10) to protrude through a center hole (C) in the disk (D), the magnet (11) being positioned at least partially within the hub, said hub being preferably open at the top and said clamper including an projection (9) on its side facing the turntable (4) when positioned thereon, said projection being adapted to project through the open top in the turntable hub, such that only a small variable gap (G) is left between the projection and the magnet.

11. A device for reading and/or writing data from or on a disk comprising the disk drive unit according to claim 1.
